(19) United States
(12) Patent Application Publication
(10) Pub. No.: US 2026/0038387 A1
(43) Pub. Date: Feb. 5, 2026

(54) VISUAL READING DECODING SYSTEM AND METHODS OF PERFORMING THE SAME

(71) Applicant: David Simpson, Land O Lakes, FL (US)

(72) Inventor: David Simpson, Land O Lakes, FL (US)

(21) Appl. No.: 19/288,068

(22) Filed: Aug. 1, 2025

Related U.S. Application Data
(60) Provisional application No. 63/679,360, filed on Aug. 5, 2024.

(51) Int. Cl. G09B 17/00

(52) U.S. Cl. CPC G09B 17/003

(57) ABSTRACT

A learning system for students with specific learning disabilities includes a program to utilize graphical icons in conjunction with phonetic breakdowns of words. The program iterates displaying the graphical icon in place of certain letters, displaying both the graphical icon and the letters, and displaying just the letters. As a student completes each iteration at a minimum proficiency, the program iterates to present the next difficulty level.

### STATEMENT OF RELATED APPLICATION(S)

This application claims the benefit of U.S. Provisional Patent Application No. 63/679,360 filed on Aug. 5, 2024, the disclosure of which is hereby incorporated by reference herein in its entirety.

### TECHNICAL FIELD

This invention relates to the field of aids for teaching students with learning disabilities, and systems and methods thereof.

### BACKGROUND

Reading is a required skill that should be mastered at a young age. However, there are a number of learning disabilities that make reading difficult if not impossible. Overcoming these disabilities requires hours of training and education in a mostly one on one setting with a professional. With more and more strain being put on personal time, one on one education sessions are very hard to schedule and maintain.

Therefore, a need exists for a system that will assist persons with learning disabilities in learning to read.

### SUMMARY

In a first aspect of the invention, there is provided a learning system including a plurality of words stored in a memory; a plurality of graphical icons stored in the memory; and an analysis unit configured to retrieve each word of the plurality of words, and separate each word into vowels and vowel sounds; wherein the analysis unit assigns one graphical icon of the plurality of graphical icons to each vowel and to each vowel sound.

In another aspect, any one or more aspects or features described herein may be combined with any one or more other aspects or features for additional advantage.

Other aspects and embodiments will be apparent from the detailed description and accompanying drawings.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a visual reading decoding system consistent with the present invention.

FIG. 2A depicts one embodiment of a visual teaching unit.

FIG. 2B depicts one embodiment of a communication device consistent with the present invention.

FIG. 3 depicts a schematic representation of a method used to visually teach reading to a user.

FIG. 4 depicts a schematic representation of a method of creating a task for a user to perform.

FIG. 5 depicts a schematic representation of the vowel and vowel sounds table showing each vowel and vowel sound and the associated icon;

FIG. 6 depicts an illustrative example of icons being associated with vowels and vowel sounds in words;

FIG. 7 depicts a schematic representation of a process of displaying words with graphical representations of vowels and vowel sounds;

FIG. 8 depicts a schematic representation of a process of identifying letter patterns in words;

FIG. 9 depicts an illustrative example of capitalizing letters in a word to indicate the letter should be pronounced;

FIG. 10 depicts an illustrative example of consonants in a word being capitalized and silent ‘e’ letters being removed;

FIG. 11 depicts a schematic representation of a process of teaching a user to pronounce a word correctly; and

FIG. 12 depicts a schematic representation of an administrator managing the process of presenting and managing the content presented to the user

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The visual reading decoding system 100 incorporates visual cues, specialized instructional methods and advanced speech interaction technology to teach and develop reading decoding skills. Visual icons and intuitive letter patterns are used to assist students in learning vowel sounds as they learn to read aloud. Specific reading objectives are determined through pretesting administered by the system to each student. The system tracks each student's progress and translates the progress to an administrator for customization of the program for each student.

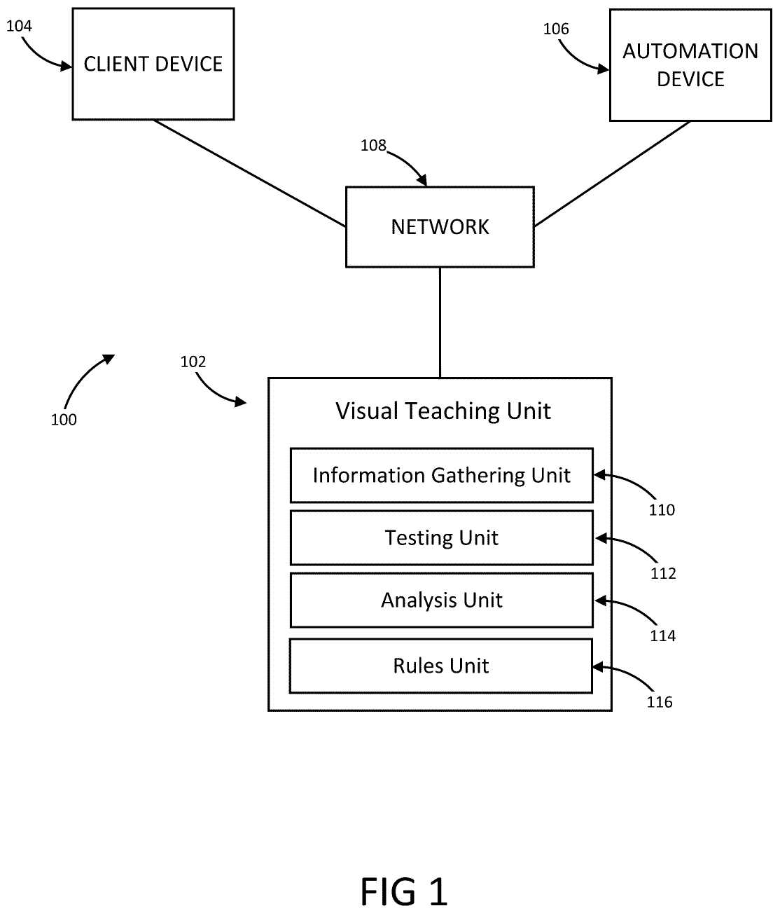

FIG. 1 depicts one embodiment of a visual reading decoding system 100 consistent with the present invention. The visual reading decoding system 100 includes a visual teaching unit 102, a first communication device 104, a second communication device 106 each communicatively connected via a network 108. The visual teaching unit 102 further includes an information gathering unit 110, a testing unit 112, an analysis unit 114 and rules unit 116.

The information gathering unit 110 and testing unit 112 may be embodied by one or more servers. Alternatively, each of the analysis unit 114 and rules unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the row identification device may be servers, workstations, network appliances or any other suitable data storage devices. In another embodiment, the communication devices 104 and 106 may be any combination of cellular phones, telephones, personal data assistants, or any other suitable communication devices. In one embodiment, the network 108 may be any private or public communication network known to one skilled in the art such as a local area network (“LAN”), wide area network (“WAN”), peer-to-peer network, cellular network or any suitable network, using standard communication protocols. The network 108 may include hardwired as well as wireless branches. The information gathering unit 110 may include a microphone.

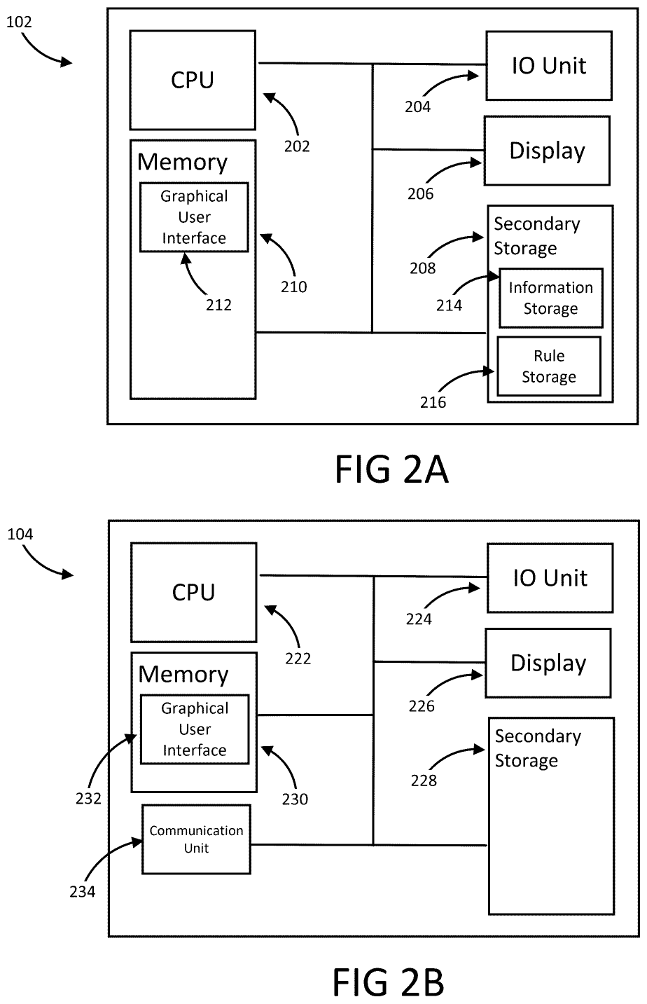

FIG. 2A depicts one embodiment of a visual teaching unit 102. The visual teaching unit 102 includes a network I/O device 204, a processor 202, a display 206 and a secondary storage 208 running image storage unit 210 and a memory 212 running a graphical user interface 214. The image gathering unit 112, operating in memory 208 of the visual teaching unit 102, is operatively configured to receive an image from the network I/O device 204. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The rules unit 116 may be a compiled program running on a server, a process running on a microprocessor or any other suitable port control software.

FIG. 2B depicts one embodiment of first and second communication devices 104, 106 consistent with the present invention. The first and second communication devices 104, 106 each includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network or any suitable network, using standard communication protocols. The network 108 may include hardwired as well as wireless branches.

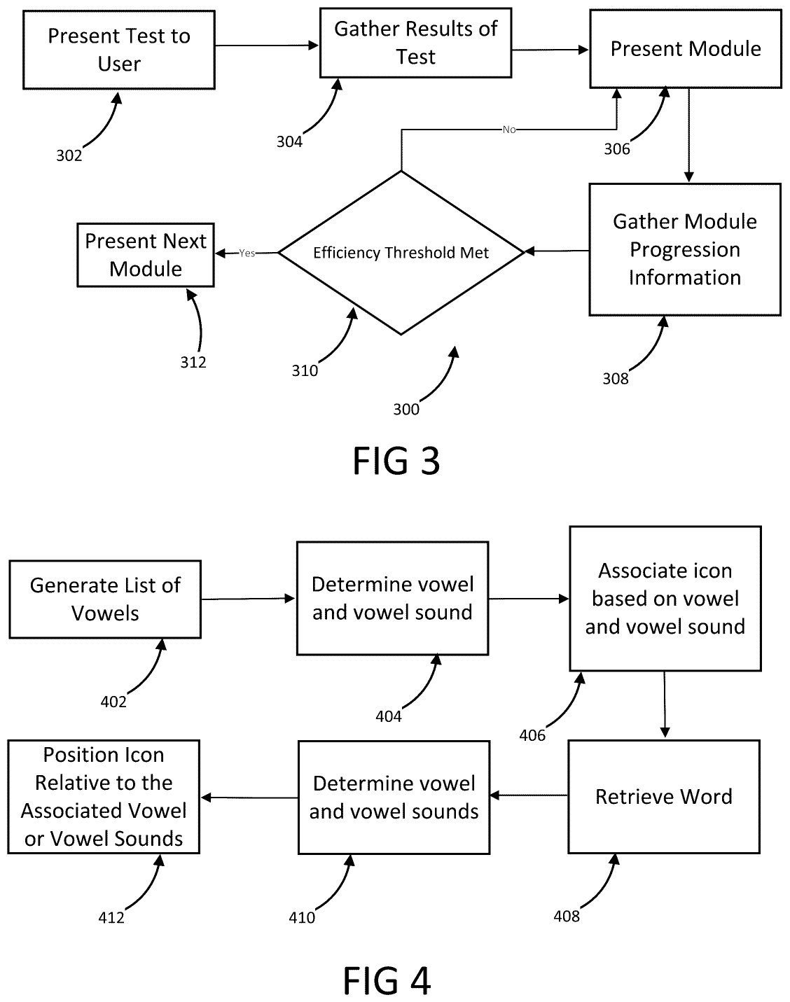

FIG. 3 depicts a schematic representation of a process used to visually teach reading to a user. In step 302, a user is presented with a pre-test via the testing unit 112 to determine the reading efficiency of the user and to identify any issues that may require correction in the user's reading ability. The test may include presenting a variety of words to the user at different speeds and different complexity levels. In one embodiment, the testing unit 112 selects future questions/words in the test based on the user's accuracy with prior questions/words presented in the test. In another embodiment, the testing unit 112 adjusts the speed with which words are shown to the user based on the user's accuracy at prior speeds. In one embodiment, the testing unit 112 or the analysis unit 114 may adjust the frequency with which the words are presented to the user such that the words are presented at a faster or slower rate based on the user's performance of each task. The baseline time represents the time a word is presented to a user during a module or a test. In one embodiment, the baseline is manually adjusted by the administrator. In one embodiment, the testing unit 112 and analysis unit 114 adjusts the speed words are presented to the user based on the user's efficiency progressing through a module or a test. In one embodiment, the administrator sets the baseline. In step 304, the testing unit 112 gathers the information learned from the pre-test and stores the results in memory. The information learned from the pre-test is used to generate a series of modules that will be used to teach the user more effective techniques for reading based on the user's responses to questions in the pre-test.

In step 306, a module is presented to the user that presents the user with different activities to perform that will train the user in different methods of reading. The information gathering unit 110 presents the content of each module to the user and the analysis unit 114 analyzes each student's responses to determine the accuracy and consistency of each response. In one embodiment, the analysis unit 114 may adjust the content of the module based on the user's responses and accuracy in performing each of the tasks. As an illustrative example, a user may be shown a series of words with cues inserted to assist the reader in identifying different vowels and vowel sounds. The analysis unit 114 may adjust the frequency with which the words are presented to the user such that the words are presented at a faster or slower rate based on the user's performance of each task.

In step 308, the analysis unit 114 gathers information on the user's progression through the tasks in each module. Once the user has performed each task to a baseline level, a test is presented to the user to determine the user's performance level of the tasks presented in the module. The content of the test is determined based on the user's performance of the tasks in the module with the analysis unit 114 adjusting the complexity of the tasks and the time required to complete each task during the test. When the test is completed, the analysis unit 114 generates an efficiency score for the user. In step 310, the analysis unit 114 determines if the user's efficiency score is greater than a predetermined threshold. If the user's efficiency score is lower than the predetermined threshold, the analysis unit 114 presents a module containing tasks directed to correcting the deficiencies identified in the test. If the user's efficiency is above the threshold, the analysis unit 114 presents a new module to the user that introduces a new set of tasks directed at mastering a new reading skill in step 312.

FIG. 4 depicts a schematic representation of a process of creating a task for a user to perform. In step 402, the information gathering unit 110 generates a list of vowels that are commonly used in words. In step 404, the analysis unit 114 determines the vowel and vowel sounds for each vowel and vowel sound generated. In one embodiment, each vowel may have more than one vowel sound based on the usage of the vowel. In step 406, the analysis unit 114 associates an icon with each vowel and each vowel sound. Each icon is logically associated with the vowel sound in a table or database that is stored in memory and can be retrieved at a later time. In step 408, a word is retrieved from a listing of commonly used words. The listing of words may be stored in the memory of the visual teaching unit. The listing of words may be categorized based on topic, frequency of use, complexity, or any other characteristic of the word. In step 410, the analysis unit 114 determines the vowel and vowel sounds in each word. In one embodiment, the analysis unit 114 parses each word and compares the components of each word with known vowels and vowel sounds. In step 412, an icon associated with each vowel and vowel sound is presented to the user with the icon being positioned above each vowel or vowel sound.

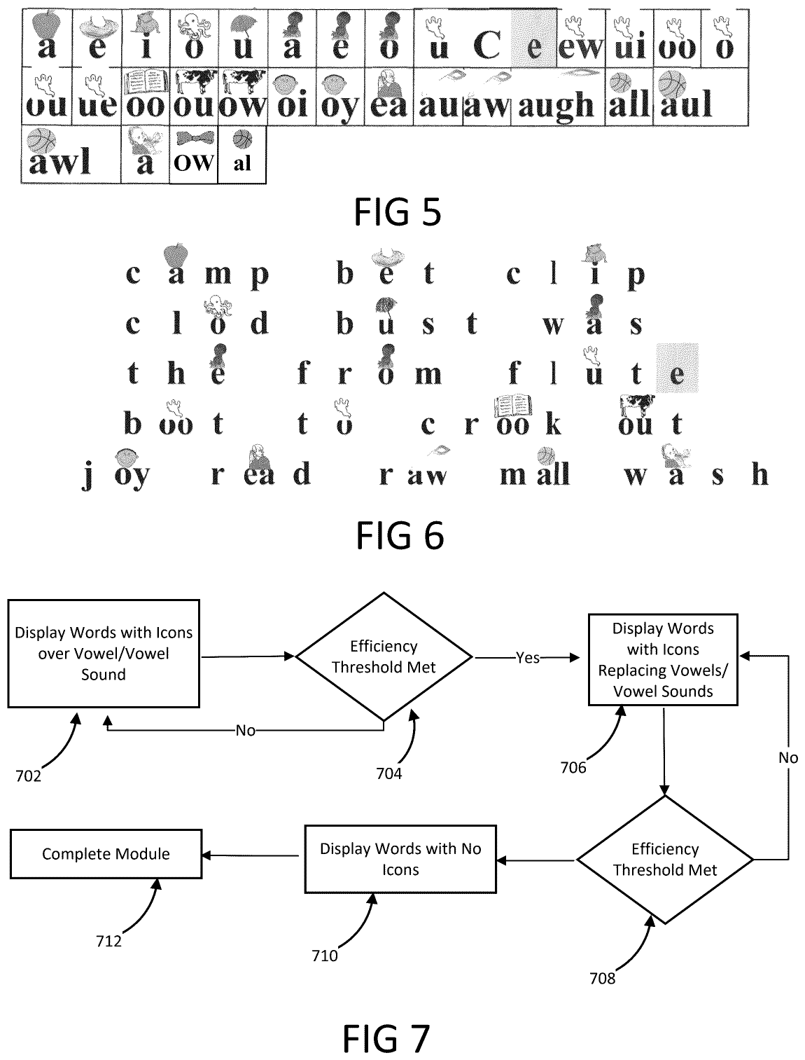

FIG. 5 depicts a schematic representation of the vowel and vowel sounds table showing each vowel and vowel sound and the associated icon. The vowel sounds may include, but are not limited to, short a, short e, short o, short u, schwa a, schwa o, u with predetermined vowel pattern, ew, ai, oo, ou, uc, oo, ow, ou, ow, oi, oy ca, au, aw, augh, all, awl, aul, a, and o. Each vowel and vowel sound is associated with an icon indicating how the vowel or vowel sound should be read. In one embodiment, one icon may be associated with more than one vowel or vowel sound.

FIG. 6 depicts an illustrative example of icons being associated with vowels and vowel sounds in words. The analysis unit 114 places an icon associated with a vowel or vowel sound above the respective vowel or vowel sound in each word. As an illustrative example, the letter ‘a’ is identified by the analysis unit 114 in the word “camp.” The letter ‘a’ is associated with an icon of an apple in a vowel and vowel sounds table. The analysis unit 114 retrieves the apple icon image and places the apple icon above the letter ‘a’ in the word camp.

FIG. 7 depicts a schematic representation of a process of displaying words with graphical representations of vowels and vowel sounds. In step 702, icons associated with vowels and vowel sounds are positioned above the vowels and vowel sounds in words. A user is presented with the words and icons and is tested to determine if the user can successfully read each word with the associated icon. In step 704, the user is tested, via the testing unit 112, to determine the efficiency with which the user reads the words. If the user's efficiency score is less than a predetermined level, the analysis unit 114 presents the user with additional words with icons above the vowels and vowel sounds to improve the user's efficiency. If the user's efficiency is greater than a predetermined level, the analysis unit 114 presents the user with a series of words having the vowel and vowel sounds replaced with icons in step 706. The user is presented with the words with vowel and vowel sounds replaced with icons and is tested by the testing unit 112 to determine the user's efficiency in reading the words. In step 708, if the user's efficiency is below a predetermined threshold, the analysis unit 114 presents the user with additional words having icons replacing the vowels and vowel sounds. If the user's efficiency is above the predetermined threshold, the user is presented with words that do not contain any icons in step 710. In step 712, the module is completed once the user's efficiency reading words with no icons is above a predetermined level.

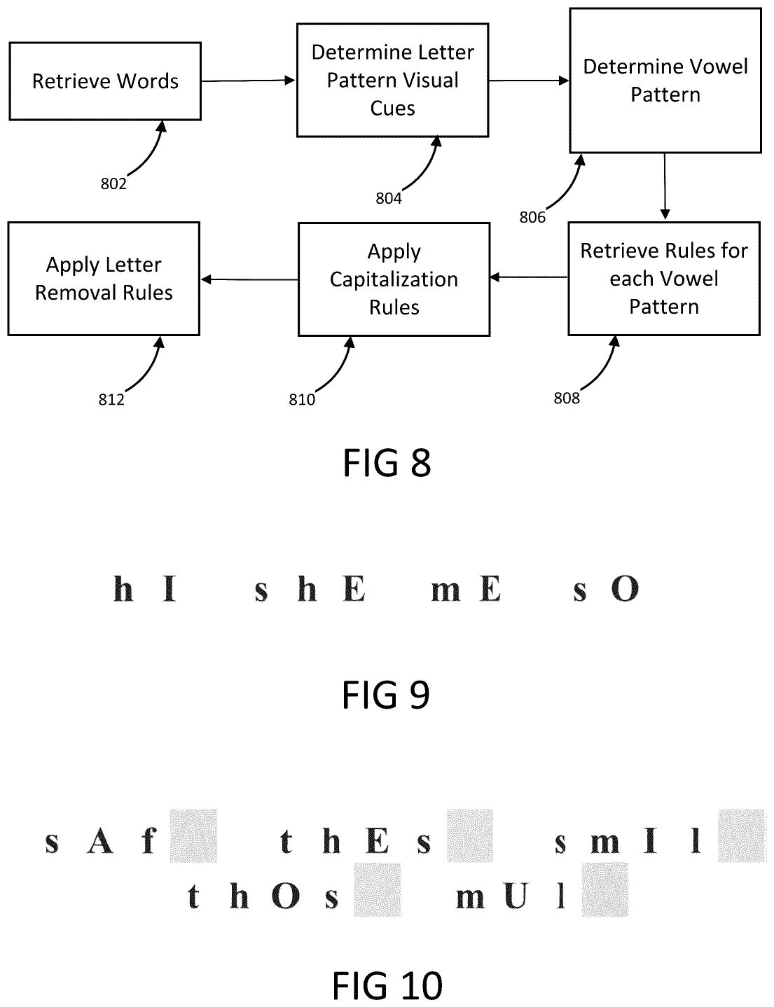

FIG. 8 depicts a schematic representation of a process of identifying letter patterns in words. In step 802, the analysis unit 114 retrieves words from a listing of words. In step 804, the analysis unit 114 parses each word and identifies letter patterns in each word. The letter patterns may be identified by comparing portions of each word with predetermined letter patterns. In step 806, the vowel pattern of each word is determined by the analytical unit 114. In step 808, the rules unit 116 retrieves the rules associated with each identified vowel and vowel pattern in the words. The rules include instructions on how each vowel and vowel pattern is displayed in the word presented to the user. In step 810, the analytical unit 114 applies capitalization rules to each word. In one embodiment, the capitalization rule capitalizes the end vowel in a word. The user is instructed to vocalize the name of the capitalized letter when the user sees the ending vowel capitalized. The rule may also apply to a long vowel in a word having a silent letter ‘e’ where the word has a vowel followed by a consonant and then the letter ‘e’ and the vowel before the consonant is capitalized. In step 812, rules removing letters from words are applied. The analysis unit 114 removes the silent ‘e’ letters from each word signaling the user to ignore the pronunciation of the letter ‘e’ once it is removed. In another embodiment, the letter ‘e’ is shaded, but not removed from the word. The shading indicates to the user that the letter ‘e’ should be ignored and not pronounced.

FIG. 9 depicts an illustrative example of capitalizing letters in a word to indicate the letter should be pronounced. As an illustrative example, the letter ‘I’ in the word “Hi” indicates that the letter ‘I’ should be pronounced.

FIG. 10 depicts an illustrative example of vowels in a word being capitalized and silent ‘e’ letters being removed. As an illustrative example, the user would read the word “safe” pronouncing the letter ‘a’ and not pronouncing the letter ‘e’. In one embodiment, the user is presented with an audio and a visual indicator that a task was correctly completed. In one embodiment, the use is presented with a video before each module starts. In one embodiment, the user is presented with a video describing areas of improvement for the user.

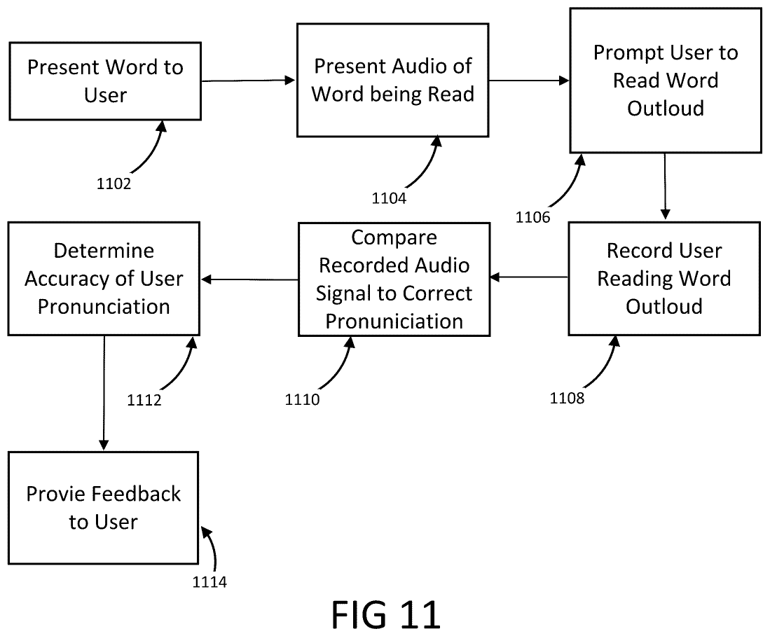

FIG. 11 depicts a schematic representation of a process of teaching a user to pronounce a word correctly. In step 1102, a word is presented to the user. In step 1104, an audio recording of the word being pronounced by a person is played. In one embodiment, an indicator such as a light is placed above the word being pronounced. In step 1106, the user is prompted to read the word aloud. In step 1108, the user's voice reading the word is recorded. In step 1110, the user's recorded voice is analyzed by the analysis unit 114 by comparing the audio of the user's voice to audio of the word being spoken correctly In step 1112, the analysis unit 114 determines the accuracy of the user's pronunciation. In step 1114, the user is presented with feedback on the user's reading of the word to correct pronunciation.

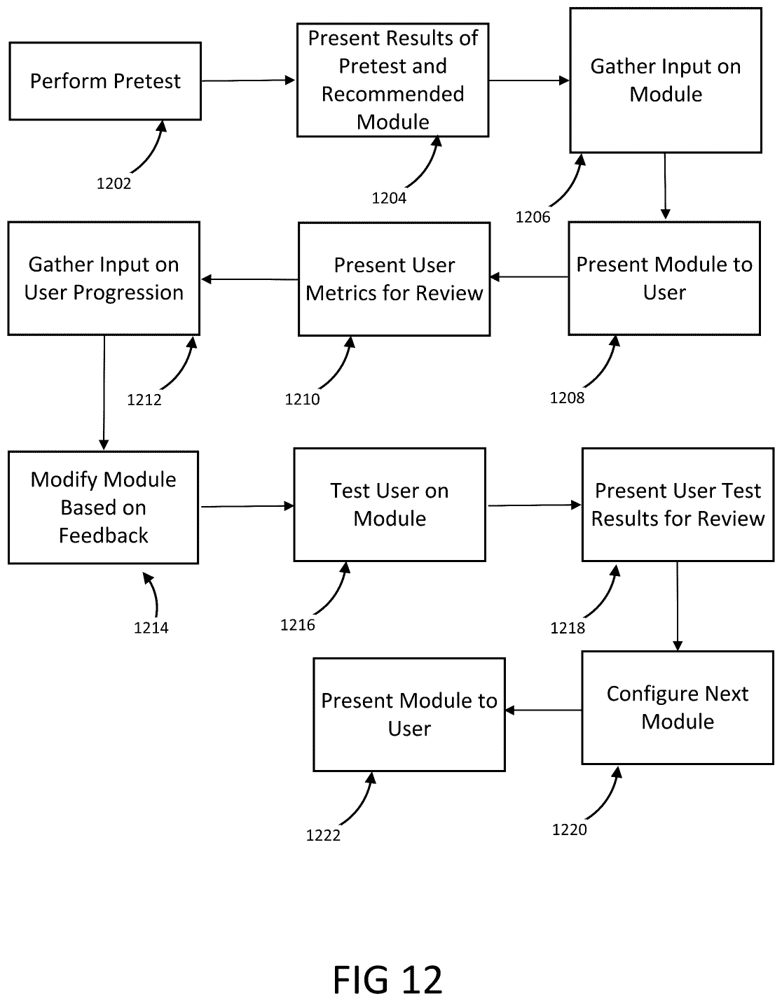

FIG. 12 depicts a schematic representation of an administrator managing the process of presenting and managing the content presented to the user. In step 1202, the testing unit 112 presents a pretest for the user to take prior to starting any module. The pretest is configured to determine the efficiency of user's ability to read word presented during the pretest. In step 1204, the results of the pretest are presented to an administrator. The results include, but are not limited to, the duration of the test, the time the user took to answer each question/word, the efficiency of the user in competing the test, the questions/words the user got correct, the questions/words the user got wrong, the category of the questions/words the user got correct and wrong. Based on the results of the pretest, the administrator configures the module that will be presented to the user.

In step 1206, the testing unit 112 gathers information on the module that will be presented to the user. The information on the unit includes, but is not limited to, the words and vowels covered by the module, the initial speed the words are presented to the user, the goal of the module, the expected outcome of the module and the minimum efficiency score for the module to progress to the next module. In step 1208, the module is presented to the user. The user works through the tasks presented in the module with the user's progress working through the tasks being recorded by the analysis unit 114. In one embodiment, the user's progress may trigger an alert to the administrator to intervene with the user to assist the user in progressing through the module. As an illustrative example, the analysis unit 114 may send an alert to the administrator if the user is consistently struggling with a word or category of words that results in the administrator working with the user to progress through the module.

In step 1210, when the module is complete, the analysis unit 114 produces metric information on the user's performance. The metric information provides an indication of how the user progressed through different aspects of the module. In one embodiment, the metric includes video and audio recording of the user reading words, phrases, and sentences. In step 1212, the administrator gathers the metric information and makes a determination on whether to progress the user to the next module. In step 1214, the administrator modifies the current module based on the metrics sent from the analytical unit 114. In one embodiment, the administrator modifies the module to address deficiencies the user had in completing the module the first time. In step 1216, the user is presented with a test to determine the user's efficiency with the current module. In one embodiment, the test is a timed test. In another embodiment, the test is an untimed test. In step 1218, the results of the test are presented to the administrator for review. The administrator determines, based on the test results, whether the user should progress to the next module. In step 1220, the administrator configures the net module based on the user's performance on the previous module and the user's test performance. In one embodiment, the administrator modifies the timing with which words are presented to the user, the category of words presented to the user and the allowed efficiency before the user progresses to the next module. In step 1222, the next module is presented to the user for completion.

Those skilled in the art will recognize improvements and modifications to the preferred embodiments of the present disclosure. All such improvements and modifications are considered within the scope of the concepts disclosed herein and the claims that follow.

What is claimed is:

1. A learning system, comprising:
a plurality of words stored in a memory;
a plurality of graphical icons stored in the memory; and
an analysis unit configured to:
retrieve each word of the plurality of words, and
separate each word into vowels and vowel sounds,
wherein the analysis unit assigns one graphical icon of the plurality of graphical icons to each vowel and to each vowel sound.
